(19) United States
(12) Patent Application Publication
(10) Pub. No.: US 2002/0194289 A1
(43) Pub. Date: Dec. 19, 2002

(54) Configuring devices using server responses

(76) Inventors: Glenn R. Engel, Snohomish, WA (US); Glen Purdy JR., Snohomish, WA (US); Harry G. Plate, Snohomish, WA (US); Jefferson B. Burch, Palo Alto, CA (US)

Correspondence Address: AGILENT TECHNOLOGIES, INC., Legal Department, DL429, P. O. Box 7599, Loveland, CO, 80537-0599, US

(21) Appl. No.: 09/884,353

(22) Filed: Jun. 18, 2001

(51) Int. Cl. G06F 15/16

(52) U.S. Cl. 709/208; 709/220

(57) ABSTRACT

A method for configuring a device which uses server responses to transport configuration data to the device. A system according to the present teachings includes a device that transfers a request message via a communication network and a configuration server that receives the request message via the communication network and in response transfers a response message to the device via the communication network wherein the response message includes a set of configuration data for the device.

### BACKGROUND OF THE INVENTION

1. Field of Invention

The present invention pertains to the field of configuring devices. More particularly, this invention relates to configuring devices using server responses.

2. Art Background

A wide variety devices have behaviors which are governed by a configuration for the device. The process of setting or altering the configuration of a device is often referred to as configuring the device. For example, a measurement device may be configured to obtain a measurement at a particular time or at particular periodic intervals. As another example, a signal generator device may be configured to generate a signal having a particular frequency and/or amplitude. These are only a few examples of devices which may be configured and numerous others exist.

It is common for devices to be placed at relatively remote physical locations. One prior method for configuring such a remote device is to provide a computer system such as a personal computer at the remote location. The computer system is usually provided with a customized hardware/software interface for configuring the remote device. Typically, the computer system obtains configuration information pertaining to the remote device via a telephone line from a control center for the device and then configures the remote device accordingly. Typically, the specialized hardware/software on the remote computer system and central computer system must be adapted to a variety of different devices. Unfortunately, such customization can greatly increase the costs associated with configuring remote devices.

### SUMMARY OF THE INVENTION

A method for configuring a device is disclosed which uses server responses to transport configuration data to the device. A system according to the present teachings includes a device that transfers a request message via a communication network and a configuration server that receives the request message via the communication network and in response transfers a response message to the device via the communication network wherein the response message includes a set of configuration data for the device.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows an arrangement for configuring a device according to the present teachings;

FIG. 2 illustrates a method for configuring a device according to the present teachings;

FIG. 3 shows an arrangement that enables a user at a workstation to configure the device according to the present teachings;

FIG. 4 shows an arrangement for configuring a set of devices according to the present teachings.

### DETAILED DESCRIPTION

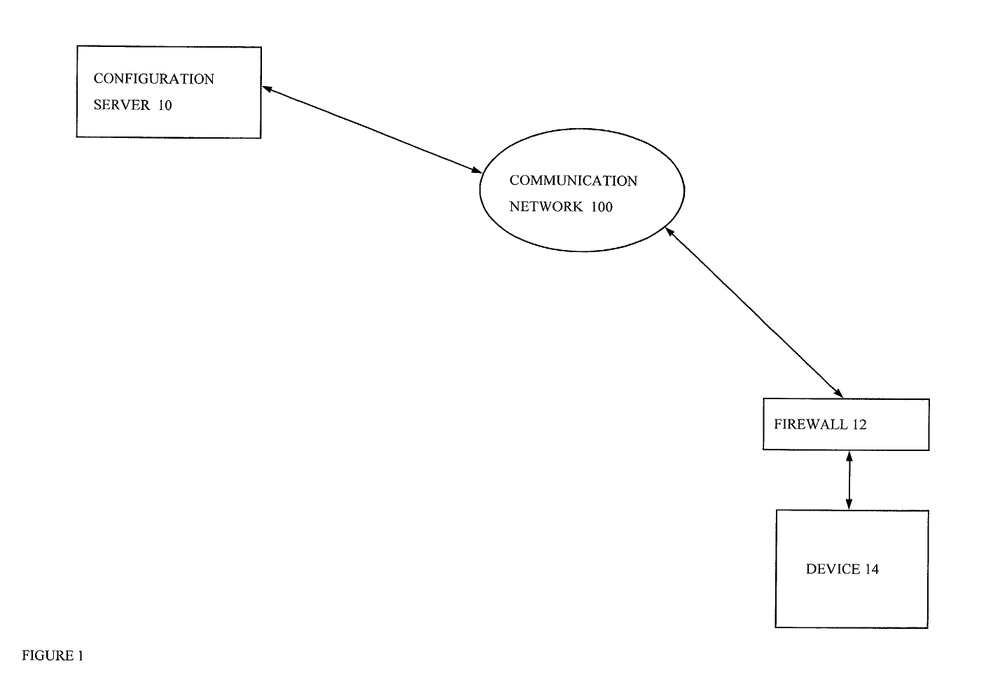

FIG. 1 shows an arrangement for configuring a device 14 according to the present teachings. The device 14 is capable of a set of behaviors which are governed by configuration data. The configuration data for the device 14 is obtained from a configuration server 10 via a communication network 100.

In one embodiment, the communication network 100 may be the world-wide web of the Internet. Alternatively, the communication network 100 may be another communication network which supports the Hyper-Text Transfer Protocol (HTTP). In other embodiments, other client-server communication protocols may be employed.

In one embodiment, the device 14 is protected from unauthorized accesses by a firewall 12. In another embodiment, the device 14 connects to the communication network 100 without a firewall.

The firewall 12 deflects communication transactions that originate on the communication network 100 from reaching the device 14. For example, the firewall 12 deflects HTTP GET and HTTP POST commands, etc. that initiate with the configuration server 10. This prevents the configuration server 10 from initiating a transfer of configuration data to the device 14 via the communication network 100 without some specialized configuration of the firewall 12.

The firewall 12 allows communication transactions that originate with the device 14 to reach the communication network 100. For example, the firewall 12 allows HTTP GET and HTTP POST commands, etc. from the device 14 to reach the communication network 100. The firewall 12 also allows server responses from the communication network 100 to pass back through to the device 14 for communication transactions that were initiated by the device 14. This allows the device 14 to request configuration data from the configuration server 10 by generating an HTTP POST command request and obtain the configuration data in a response to the HTTP POST command request. In an alternative embodiment, the device 14 requests configuration data from the configuration server 10 by generating an HTTP GET command request and obtains the configuration data in a response to the HTTP GET command request.

The device 14 may be any device which is capable of behaviors that are governed by configuration data. For example, the device 14 may include sensor/measurement behaviors, actuator/stimulus behaviors, or device control behaviors or any combination of these. Examples of actuator/stimulus behaviors include signal generators, heaters, mechanical actuators, devices that apply chemical stimuli, etc. Examples of sensor/measurement behaviors include temperature sensors, humidity sensors, chemical sensors, mechanical movement sensors, signal receivers, etc. Examples of device control behaviors include electrical, chemical, mechanical system controllers.

The device 14 is capable of communication according to the HTTP prtocol. The device 14 includes the hardware/software elements for performing HTTP communication via the communication network 100 as an HTTP client. The device 14 may include the functionality of an HTTP server. Alternatively, the device 14 may be attached to a separate device which is capable of HTTP communication.

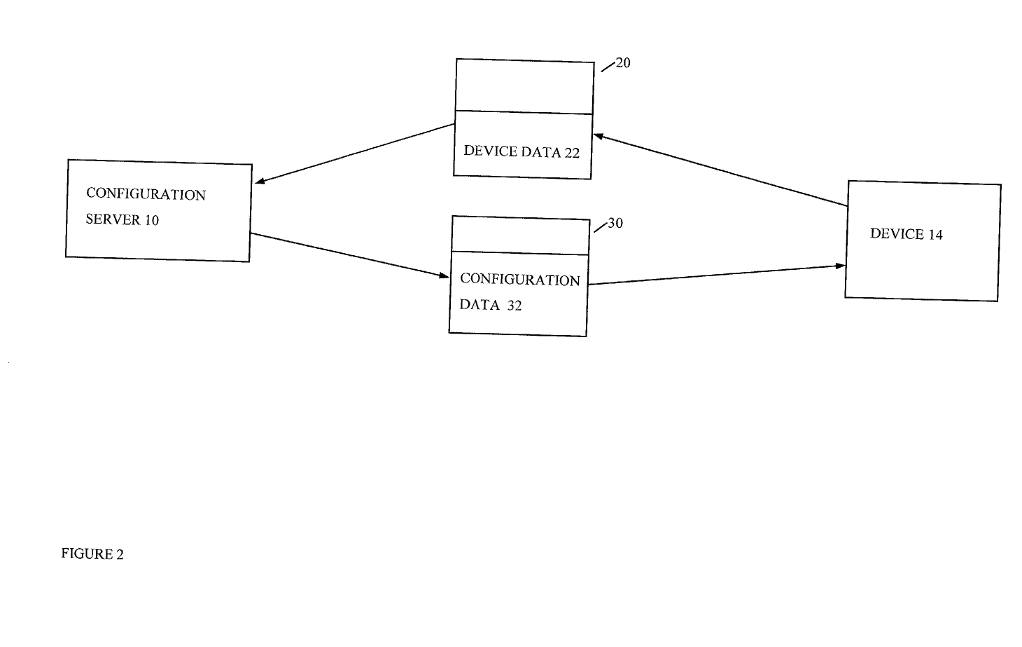

FIG. 2 illustrates a method for configuring the device 14 through the firewall 12 according to the present teachings. The device 14 generates a request message 20 that specifies the configuration server 10 and transfers the request message 20 through the firewall 12 and on to the configuration server 10 via the communication network 100. The request message 20 includes a set of device data 22.

In one embodiment, the request message 20 is an HTTP Post command request which specifies the configuration server 10 using a uniform resource locator (URL) associated with the configuration server 10. The device data 22 may be embedded in the forms data associated with the HTTP POST command according to the HTTP protocol.

The device data 22 may be data which is generated by the device 14 when performing one or more of its behaviors. In such a case the device 14 uses the request message 20 to provide data generated by its behaviors back to the configuration server 10. The configuration server 10 may log the device data 22, relay the device data 22 onto another node or device, or use the device data 22 to determine new configuration data for the device 14 or perform any combination of these functions.

For example, the device 14 may be a sensor which may be configured to obtain measurements at periodic intervals and/or at particular times and/or under particular conditions. The device 14 may perform measurements on a system (not shown) or perform measurements to monitor environmental conditions at a remote site. The device 14 may use the request message 20 to report obtained measurements back to the configuration server 10 as the device data 22. The device data 22 may include multiple sets of measurement data depending on how the device 14 is configured.

In another example, the device 14 may perform an error checking and/or alarm function. The device 14 may use the request message 20 to report errors and/or alarms back to the configuration server 10 and specify the error/alarm with the device data 22.

The device data 22 may carry a heartbeat indication which is generated periodically by the device 14 and sent in a request to inform the configuration server 10 that the device 14 is alive and functioning. The period with which the device 14 generates the heartbeat indication may be configured by the configuration server 10.

The device 14 may generate the request message 20 in response to a page from the configuration server 10 or page from some other device. The device 14 may have a receiver for the page or may have an external pager that notifies the device 14 when a page message is received.

The configuration server 10 responds to the request message 20 by generating a response message 30 and transferring it back to the device 14 via the communication network 100. The response message 30 includes a set of configuration data 32. The response message 30 passes through the firewall 12 to the device 14 as a normal response to the request message 20 which initiated the communication transaction with the configuration server 10. In one embodiment, the response message 30 includes an acknowledgment to the HTTP POST according to the HTTP protocol and also includes the configuration data 32.

The configuration data 32 provides configuration information pertaining to the behaviors of the device 14. The configuration data 32 may specify a heartbeat period for the device 14. The configuration data 32 may specify a time or times or time intervals at which the device 14 is to obtain measurements and/or apply a stimulus and/or perform some other behavior. The configuration data 32 may identify the type or types of measurements to be obtained by the device 14. The configuration data 32 may identify the type or types of stimuli to be applied by the device 14.

The configuration data 32 may include any parameter associated with measurement behaviors and/or stimulus behaviors and/or control behaviors of the device 14. For example, if the device 14 is a signal generator then the configuration data 32 may include parameters associated with amplitudes, frequencies, periods, etc. of signals generated by the device 14.

The device 14 extracts the configuration data 32 from the response message 30 and interprets the commands and associated data in the configuration data 32 to alter its configuration. For example, commands and associated data in the configuration data 32 may be interpreted to write data to specified registers in the device 14 that control its behaviors.

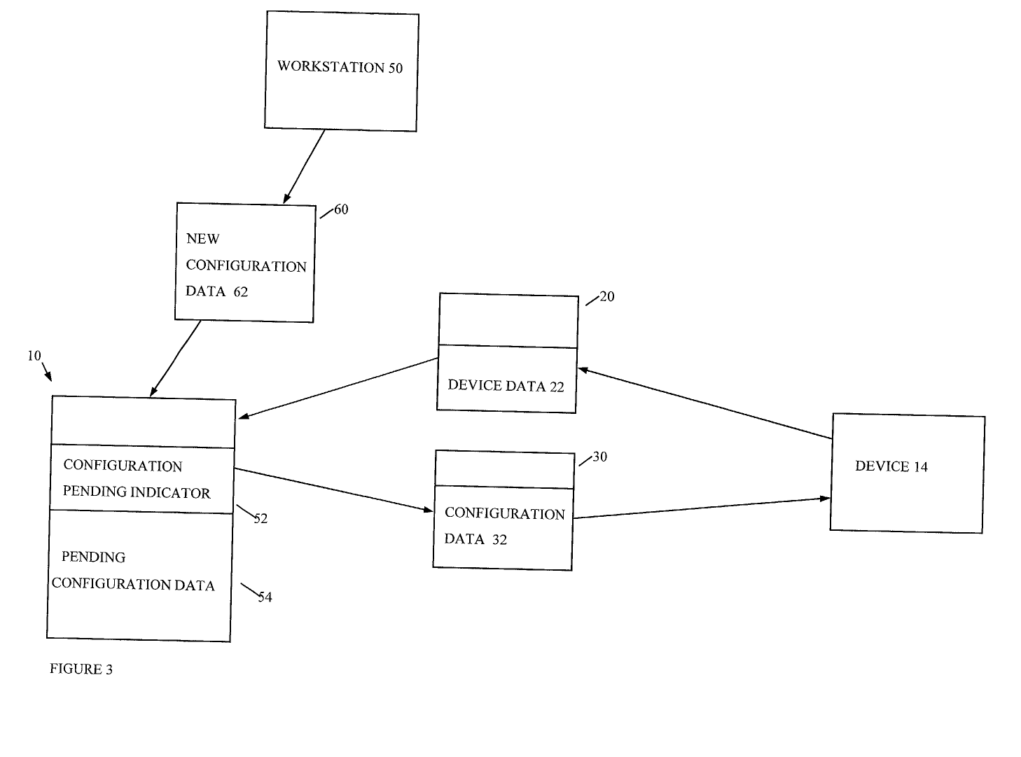

FIG. 3 shows an arrangement that enables a user at a workstation 50 to configure the device 14 according to the present teachings. A user at the workstation 50 enters set of new configuration data 62 for the device 14. The new configuration data 62 may be arranged as commands and associated parameters which are to be interpreted and executed by a processor in the device 14.

The workstation 50 transfers the new configuration data 62 to the configuration server 10 in a message 60. The message 60 may be transferred to the configuration server 10 via the communication network 100 or via some other communication path between the workstation 50 and the configuration server 10. Alternatively, a user may provide the new configuration data 62 to the configuration server 10 using HTTP protocols. For example, the configuration server 10 may generate one or more web pages for configuring the device 14 and the workstation 50 as an HTTP client may access these web pages to enter the new configuration data 62.

The communication server 10 obtains the new configuration data 62 and stores it as a set of pending configuration data 54 for the device 14. The communication server 10 also sets a configuration pending indicator 52 when the new configuration data 62 is obtained from the workstation 50.

If the configuration pending indicator 52 is set when the request message 20 is received from the device 14, the configuration server 10 clears the configuration pending indicator 52 and reads the pending configuration data 54 and sends it back to the device 14 in the response message 30 as the configuration data 32. Otherwise, the configuration server 10 provides the normal acknowledgment to the request message 20 according to HTTP protocols.

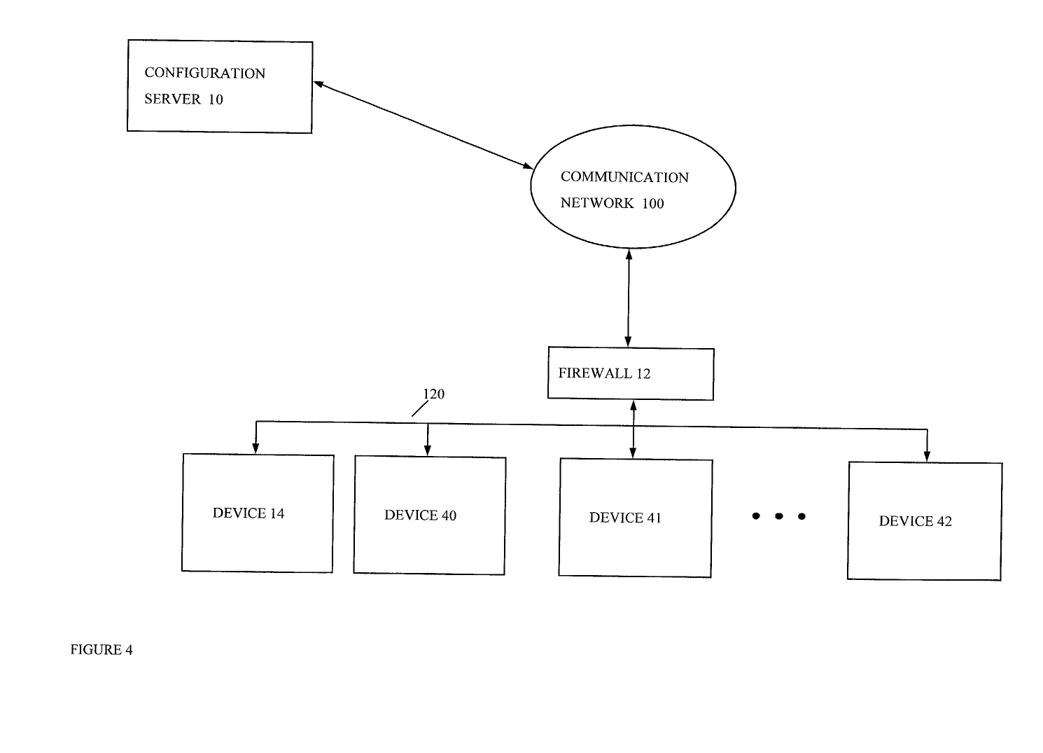

FIG. 4 shows an arrangement for configuring the device 14 and a set of devices 40-42 according to the present teachings. The device 14 and the devices 40-42 communication with each other via a local network 120. In one embodiment, the device 14 and the devices 40-42 are all behind the firewall 12 which deflects communication transactions that originate on the communication network 100 from reaching the local network 120. In another embodiment, the local network 120 connects to the communication network 100 through a communication device other than a firewall.

The device 14 generates the request message 20 to the configuration server 10 and obtains the response message 30. The response message 30 to the device 14 in this arrangement may include a configuration change message that specifies one of the devices 40-42. For example, the configuration change message may specify the IP address of one of the devices 40-42. The configuration server 10 includes the configuration change message in the request message 20 because it has pending configuration data for the device targeted by the configuration change message. The device 14 forwards the configuration change message to the appropriate one of the devices 40-42. The configuration change message may be sent between the devices 14, 40-42 using HTTP protocols. The configuration change message causes the device 40-42 that receives it to generate its own request message to the configuration server 10 for updated configuration data as described above.

The device 14 and the devices 40-42 periodically generate requests to the communication server 10 that include the heart beat indication. The scheduling of requests that include the heartbeat indication may be staggered evenly in time among the device 14 and the devices 40-42. For example, if there are a total of 10 devices on the local network 120 and each one generates a request with a heartbeat indication once every 10 minutes in a staggered schedule then the configuration server 10 is contacted once per minute, thereby giving the configuration server 10 an opportunity to send configuration data immediately to a device or cause a device with pending configuration data to send a request message to the configuration server. This reduces the configuration change delay for the devices from 10 minutes to 1 minute.

Alternatively, the devices on the local network 120 may be configured to generate requests with heartbeat indications at random times. For example, if 10 devices are configured to generate heartbeats once every 100 minutes with each device starting at some random time, the configuration server 10 would be contacted on average once every 10 minutes.

The following is an example implementation of request/response interactions between the device 14 and the server 10 in one embodiment. Numerous alternative implementations are possible according to the present teachings.

In one embodiment, the device 14 notifies the configuration server 10 that it is starting up with a registration message (operationID=“7168”) and a request for the current time (operationID=“7202”). The following is an example of a registration message and a request for the current time using an HTTP POST command request.

[image]

[image]

[image]

[image]

[image]

[image]

[image]

The foregoing detailed description of the present invention is provided for the purposes of illustration and is not intended to be exhaustive or to limit the invention to the precise embodiment disclossed. Accordingly, the scope of the present invention is defined by the appended claims.

What is claimed is:

1. A system for device configuration, comprising:
device that transfers a request message via a communication network;
configuration server that receives the request message via the communication network and in response transfers a response message to the device via the communication network wherein the response message includes a set of configuration data for the device.

2. The system of claim 1, wherein the request message comprises an HTTP POST command request.

3. The system of claim 1, wherein the request message comprises an HTTP GET command request.

4. The system of claim 1, wherein the request message includes a set of data obtained by the device when performing a set of device behaviors.

5. The system of claim 1, wherein the request message includes a heartbeat indicator for the device.

6. The system of claim 1, further comprising a workstation that transfers the configuration data to the configuration server.

7. The system of claim 6, wherein the configuration server sets a configuration pending indicator when the configuration data is received from the workstation.

8. The system of claim 6, wherein the configuration server transfers the configuration data to the device in the response message along with an acknowledgment to the request message if the configuration pending indicator is set and transfers the acknowledgment to the device otherwise.

9. The system of claim 1, further comprising a local network that enables communication among the device and a set of additional devices.

10. The system of claim 9, wherein the request message includes a configuration change message that indicates that a specified one of the additional devices has a set of pending configuration data on the configuration server.

11. The system of claim 10, wherein the device transfers the configuration change message to the specified one of the additional devices via the local network.

12. The system of claim 10, wherein the specified one of the additional devices obtains the pending configuration data by transferring an additional request message to the configuration server via the communication network.

13. A method for device configuration, comprising the steps of:
transferring a request message via a communication network;
receiving the request message via the communication network and in response transferring a response message via the communication network wherein the response message includes a set of configuration data.

14. The method of claim 13, wherein the step of transferring a request message comprises the step of transferring an HTTP POST command request via the communication network.

15. The method of claim 13, wherein the step of transferring a request message comprises the step of transferring an HTTP GET command request via the communication network.

16. The method of claim 13, wherein the step of transferring a request message comprises the step of transferring a request message that includes a set of data obtained when performing a set of behaviors.

17. The method of claim 13, wherein the step of transferring a request message comprises the step of transferring a request message that includes a heartbeat indicator.

18. The method of claim 17, wherein the step of transferring a request message that includes a heartbeat indicator comprises the step of transferring the request message with the heartbeat indicator at a random time.

19. The method of claim 13, wherein the step of transferring a request message comprises the step of transferring a request message includes a configuration change message that indicates that a set of pending configuration data is available.

20. The method of claim 19, further comprising the step of obtaining the pending configuration data by transferring an additional request message via the communication network.
